(19) United States
(12) Patent Application Publication
(10) Pub. No.: US 2014/0183944 A1
(43) Pub. Date: Jul. 3, 2014

(54) MULTI-FUNCTION SWITCH FOR VEHICLE

(71) Applicant: HYUNDAI MOTOR COMPANY, Seoul (KR)

(72) Inventors: Chung Tae Kim, Seoul (KR); Tae Hyung Lee, Gunpo (KR)

(73) Assignee: HYUNDAI MOTOR COMPANY, Seoul (KR)

(21) Appl. No.: 14/107,507

(22) Filed: Dec. 16, 2013

(30) Foreign Application Priority Data
Dec. 27, 2012 (KR) 10-2012-0155362

(51) Int. Cl. B60Q 1/00

(52) U.S. Cl. CPC B60Q 1/0076
USPC 307/10.8; 315/77

(57) ABSTRACT

A multi-function switch for a vehicle that includes an operable rotary lever and a light control plate rotatably and integrally mounted on the rotary lever and having a plurality of slits. In addition, a light source radiates light through the light control plate and a photosensor receives the light radiated from the light source through the slits and generates output voltage signals that correspond to the quantities of the received light.

### CROSS-REFERENCE TO RELATED APPLICATION

This application claims priority to and the benefit of Korean Patent Application No. 10-2012-0155362 filed in the Korean Intellectual Property Office on Dec. 27, 2012, the entire contents of which are incorporated herein by reference.

### BACKGROUND

(a) Field of the Invention

The present invention relates to a multi-function switch for a vehicle. More particularly, the present invention relates to a multi-function switch for a vehicle which performs a switching function, using a light source and a photosensor.

(b) Description of the Related Art

In general, multi-function switches for a vehicle are composed of two lever type wiper function switches and a lamp function switch mounted on a steering column. The wiper function switch is a switch that controls the operation of wipers and the lamp function switch is a switch that controls turning on and off or radiation direction of various lamps such as the headlights or the turn signals of a vehicle.

The multi-function switch for a vehicle basically includes a switch body mounted and fixed to the steering column and an operation lever rotatably combined with the switch body. A movable contact point, which pivots within the switch body, is attached to the end of the operation lever and a plurality of fixed contact points are disposed at the switch body, thus, as the operation lever pivots, the movable contact point comes in electric connect/disconnect with the fixed contact points while rotating with the operation lever, thereby implementing a switching function. In other words, the movable contact point and the fixed contact points are electrically connected or disconnected by sliding.

In the structure of the multi-function switch of the related art which implements a switching function by bringing a movable contact point and fixed contact points in connect/disconnect with each other via a sliding motion, when a foreign substance sticks to the switch, a contact point or the contact points are carbonized by an arc due to a current, thus causing poor contact.

Further, poor contact may be caused, when vibration or shock is continuously applied to the multi-function switch while a vehicle travels, or by a defect in structural design. In addition, the signals and the number of the switch contact points for various operation modes are increased with variation of the operation functions of the multi-function switch, and thus, the number of parts, the weight, and the manufacturing cost of a vehicle increase. In addition, the numbers of connector pins and wires for connection with a upper-level system that performs various operations for operation based on multi-function switch signals are also increased.

The above information disclosed in this section is only for enhancement of understanding of the background of the invention and therefore it may contain information that does not form the prior art that is already known in this country to a person of ordinary skill in the art.

### SUMMARY

The present invention provides a multi-function switch for a vehicle having advantages of precluding structural defects such as poor contact, using a non-contact type switch that generates switching signals based on a light quantity signal from a photosensor, and reducing the number of parts, the weight, and the cost of a vehicle.

An exemplary embodiment of the present invention provides a multi-function switch for a vehicle, which may include: an operable rotary lever; a light control plate rotatably and integrally mounted on the rotary lever and having a plurality of slits; a light source that radiates light through the light control plate; and a photosensor that receives the light radiated from the light source through the slits and generates output voltage signals that correspond to the quantities of the received light.

The slits may be formed circumferentially at predetermined angles. In addition, the slits may have the same length and varied widths. The widths of the slits may be circumferentially and gradually decreased. The slits may include a plurality of slit pairs that have substantially the same length and width, and the slit pairs may each have the same length and varying widths. Further, the slit pairs may include a first slit pair that correspond to headlights, a second slit pair that correspond to taillights, a third slit pair that correspond to an AUTO mode for automatically operating a lamp, and a fourth slit pair that correspond to an OFF mode for turning off the lamp. The rotary lever may be fitted through the light control plate.

The multi-function switch may further include a controller that receives an output voltage signal from the photosensor and operates a lamp corresponding to the output voltage signal.

The quantity of light received through the first slit pair may be about 80%, the quantity of light received through the second slit pair may be about 60%, the quantity of light received through the third slit pair may be about 40%, and the quantity of light received through the fourth slit pair may be about 20%. When the quantity of light is about 80%, the output voltage signal may be about 3.5V, when the quantity of light is about 60%, the output voltage signal may be about 3.0V, when the quantity of light is about 40%, the output voltage signal may be about 2.5V, and when the quantity of light is about 20%, the output voltage signal may be about 2.0V.

According to a multi-function switch for a vehicle of an exemplary embodiment of the present invention, since as a rotary lever is operated, the light control plate that has a plurality of slits may integrally rotate and varying output voltage signals may be generated based on the differences in quantity of light passing through the slits of the light control plate, and thus, a switching function may be implemented in a non-contact type.

Therefore, since it may not be necessary to use a plurality of contact type of switch contact points, poor contact due to a foreign substance sticking to the switch contact points, poor contact due to vibration or shock, or poor contact due to poor assembly or carbonization may be prevented. Further, only the structure of the slits of the light control plate needs to be changed to add a switching function, and thus, the design may be easily modified. Additionally, the connection relationship with a upper-level system performing various operations for operation based on the multi-function switch signals may be simplified, thus, it may be possible to reduce the number of wires and connector pins, and accordingly, it may be possible to reduce the number of parts, the weight, and the cost of a vehicle.

### BRIEF DESCRIPTION OF THE DRAWINGS

FIG. 1 is an exemplary schematic diagram of a multi-function switch for a vehicle according to an exemplary embodiment of the present invention;

FIG. 2 is an exemplary front view of a light control plate according to an exemplary embodiment of the present invention; and

FIG. 3 is an exemplary diagram illustrating when a light quantity is converted into a voltage in a multi-function switch for a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum). Additionally, it is understood that the term controller refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings.

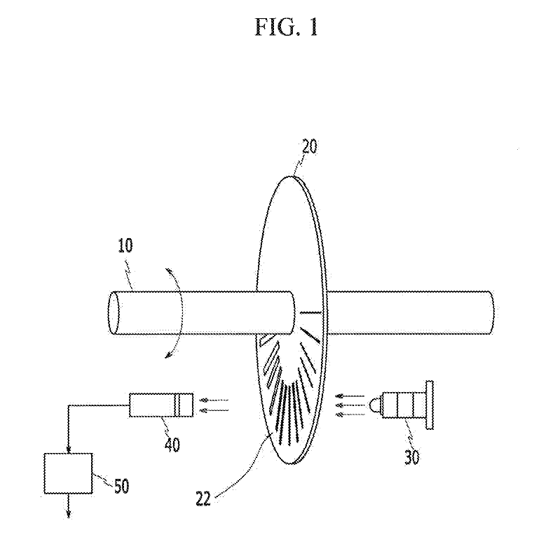

Referring to FIG. 1, a multi-function switch for a vehicle according to an exemplary embodiment of the present invention may include a rotary lever 10 that a driver or an operator may easily turn, for example, with a hand. The rotary lever 10 may be disposed rotatably clockwise or counterclockwise at a switch body mounted on a steering column (not shown).

A substantially disc-shaped light control plate 20 having a plurality of slits 22 formed through the light control plate 20 may be rotatably and integrally mounted on the rotary lever 10. The light control plate 20 may not have a disc shape and may instead be formed in appropriate shapes such as a semicircular plate or a rectangular plate, on which a plurality of slits 22 may be formed.

A light source 30 may be disposed at a first side of the light control plate 20 and a photosensor 40 may be disposed at a second side of the light control plate 20 (e.g. an opposite side). The light source 30 may be a lamp, a light-emitting diode (LED), or a light-emitting device which radiates light to the light control plate 20. In addition, the photosensor 40 may be implemented by a photoelectric transformation element that converts the quantity of light traveling through the slits 22 into a voltage signal and outputs the voltage signal.

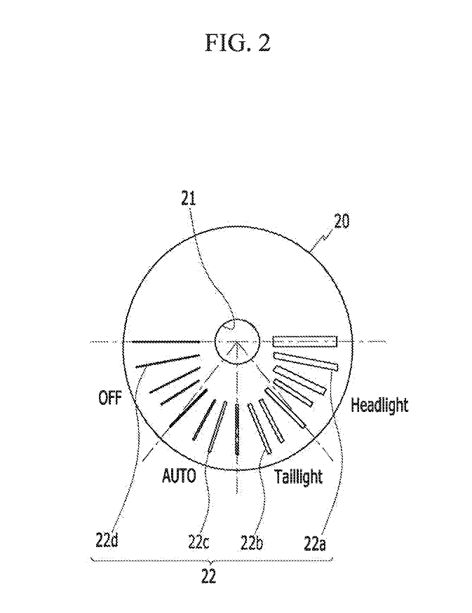

Referring to FIG. 2, the light control plate 20 having a disc shape may include an assembly aperture 21 at the center thereof into which the rotary lever 10 may be fitted. Furthermore, the slits 22 may be formed through the light control plate 20 and may be formed circumferentially at predetermined angles. The slits 22 may have the same or different lengths.

Additionally, The slits 22 may have circumferentially different widths or a plurality of slits having the same length and the same width may be formed in a plurality of slit pairs 22a, 22b, 22c, and 22d. The slit width of the first slit pair 22a may be the largest and the slit widths may gradually decrease from the second slit pair 22b to the fourth slit pair 22d. There may be differences in quantity of light passing through the slit pairs 22a, 22b, 22c, and 22d due to the difference in width of the slit pairs.

The photosensor 40 may be configured to sense the differences in quantity of light passing through the slit pairs 22a, 22b, 22c, and 22d and voltages corresponding to the differences in quantity of light can be generated. The output voltage signals generated by the photosensor 40 may be input to a controller 50 and the controller 50 may be configured to operate various lamps in response to the output voltage signals.

For example, when the photosensor 40 receives the light passing through the first slit pair 22a and inputs a corresponding output voltage signal to the controller 50, the controller 50 may be configured to turn headlights on or off. When the photosensor 40 receives the light passing through the second slit pair 22b and inputs a corresponding output voltage signal to the controller 50, the controller 50 may be configured to turn the taillights on or off. When the photosensor 40 receives the light passing through the third slit pair 22c and inputs a corresponding output voltage signal to the controller 50, the controller 50 may be configured to operate a lamp into an AUTO mode. When the photosensor 40 receives the light passing through the fourth slit pair 22d and inputs a corresponding output voltage signal to the controller 50, the controller 50 may be configured to turn off the lamp.

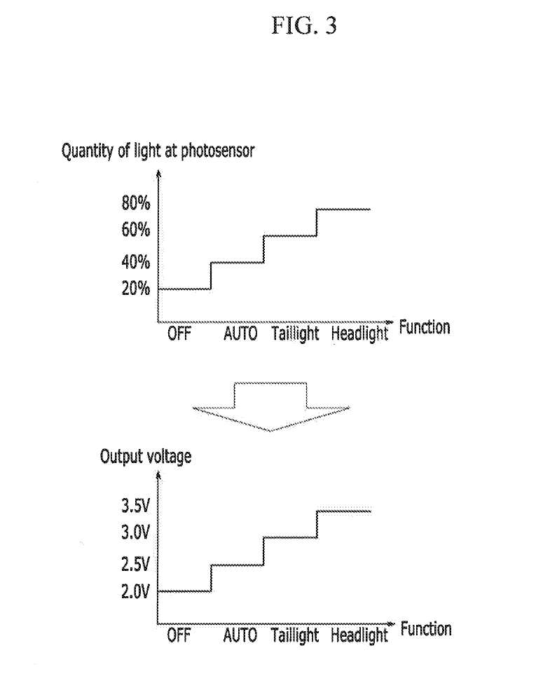

Referring to FIG. 3, the widths or the lengths of the slit pairs may be adjusted to allow the quantity of light that the photosensor 40 receives through the slit pairs 22a, 22b, 22c, and 22d to have stepped differences (e.g., varied quantity of light), and the photosensor 40 may be configured to generate voltage level signals that correspond to the differences in quantity of sensed light.

For example, when the quantity of light of about 20% is received, a voltage level signal of about 2.0V may be generated, when the quantity of light of about 40% is received, a voltage level signal of about 2.5V may be generated, when the quantity of light of about 60% is received, a voltage level signal of about 3.0V may be generated, and when the quantity of light of about 80% is received, a voltage level signal of about 3.5V may be generated,

The controller 50 may be configured to determine the output voltages from the photosensor 40 via an analog-to-digital (AD) converter and perform corresponding lamp operation functions.

FIG. 3 is an exemplary embodiment of the present invention, in which the difference values of the quantity of light and corresponding output voltage signal values may be set to vary.

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the appended claims.

Description of symbols

| | |
|---|---|
| 10: Rotary lever | 20: Light control plate |
| 30: Light source | 40: Photosensor |
| 50: Controller | |

What is claimed is:

1. A multi-function switch for a vehicle, comprising:
an operable rotary lever;
a light control plate rotatably and integrally mounted on the operable rotary lever and having a plurality of slits;
a light source that radiates light through the light control plate; and
a photosensor that receives the light radiated from the light source through the plurality of slits and generates output voltage signals that correspond to quantities of the received light.

2. The multi-function switch of claim 1, wherein the slits are formed circumferentially at predetermined angles.

3. The multi-function switch of claim 1, wherein the slits have the same length and different widths.

4. The multi-function switch of claim 3, wherein the widths of the slits are circumferentially and gradually decreased.

5. The multi-function switch of claim 1, wherein
the slits include a plurality of slit pairs that have the same length and width, and
the slit pairs each have the same length and different widths.

6. The multi-function switch of claim 5, wherein the slit pairs include:
a first slit pair corresponding to headlights;
a second slit pair corresponding to taillights;
a third slit pair corresponding to an AUTO mode for automatically operating a lamp; and
a fourth slit pair corresponding to an OFF mode for turning off the lamp.

7. The multi-function switch of claim 1, wherein the rotary lever is fitted through the light control plate.

8. The multi-function switch of claim 1, further comprising:
a controller configured to receive an output voltage signal from the photosensor and operate a lamp corresponding to the output voltage signal.

9. The multi-function switch of claim 6, wherein the quantity of light received through the first slit pair is about 80%, the quantity of light received through the second slit pair is about 60%, the quantity of light received through the third slit pair is about 40%, and the quantity of light received through the fourth slit pair is about 20%.

10. The multi-function switch of claim 9, wherein when the quantity of light is about 80%, the output voltage signal is about 3.5V, when the quantity of light is about 60%, the output voltage signal is about 3.0V, when the quantity of light is about 40%, the output voltage signal is about 2.5V, and when the quantity of light is about 20%, the output voltage signal is about 2.0V.
